(19) United States
(12) Patent Application Publication
(10) Pub. No.: US 2008/0167067 A1
(43) Pub. Date: Jul. 10, 2008

(54) Method for Mode Selection in a Multi-Mode Mobile Phone and Apparatus Thereof

(75) Inventor: Fu-Dong Wang, Nanking (CN)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INVENTEC APPLIANCES CORP., Taipei Hsien (TW)

(21) Appl. No.: 11/934,293

(22) Filed: Nov. 2, 2007

(30) Foreign Application Priority Data
Jan. 5, 2007 (TW) 96100593

(51) Int. Cl. H04M 1/00

(52) U.S. Cl. 455/552.1; 455/564; 455/569.1

(57) ABSTRACT

A method for mode selection in a multi-mode mobile phone includes the following steps: Firstly, a phone number is selected from a phone book of the multi-mode mobile phone. Then, whether the phone number is set to correspond to a predetermined communication system information is determined. The phone number is dialed by a communication system selected according to the predetermined communication system information when the phone number is set corresponding to the predetermined communication system information.

### RELATED APPLICATIONS

This application claims priority to Taiwan Application Serial Number 96100593, filed Jan. 5, 2007, which is herein incorporated by reference.

### BACKGROUND

1. Field of Invention

The present invention relates to communication devices. More particularly, the present invention relates to a method for mode selection in a multi-mode mobile phone and device thereof.

2. Description of Related Art

A dual-mode mobile phone and a multi-mode mobile phone are provided to communicate with a plurality of communication systems, such as Global System of Mobile communication (GSM) and Personal Handyphone System (PHS). The purpose of the above-mentioned mobile phones is to offer better flexibility and let users have more choices. The dual-mode mobile phone has these advantages by using both communication systems. For example, the dual-mode mobile phones may select the communication system based on the cheaper rate, and automatically select the other communication system with the greatest signal strength when the communication system based on the cheaper rate has no signal.

Today it has a further development for communication systems. Providers attract consumers by the adjusting rate, and providing a project. The project is that the calling and called parties must belong to the same provider, and the rate may be cheaper. Therefore, the project makes more users sign with the same provider.

However, a conventional dual-mode mobile phone or a conventional multi-mode mobile phone is dialed by the communication system selected according to preferential communication system information. The user merely selects one of the communication systems to dial the phone number with cheaper rate manually when the calling and called parties don't belong to the same provider.

### SUMMARY

It is an aspect of the present invention to provide a method for mode selection. The phone number is dialed by a communication system selected according to the predetermined communication system information. The above-mentioned method makes dialing speed faster and operation easier.

In accordance with an embodiment of the present invention, a method for mode selection in a multi-mode mobile phone includes the following steps: Firstly, a phone number is selected from a phone book of the multi-mode mobile phone. Then, whether the phone number is set to correspond to a predetermined communication system information is determined. The phone number is dialed by a communication system selected according to the predetermined communication system information when the predetermined communication system information is set to the phone number.

It is another an objective of the present invention to provide an apparatus, wherein the phone number is dialed by a communication system selected according to the predetermined communication system information in a multi-mode mobile phone with a plurality of communication systems.

In accordance with another embodiment of the present invention, an apparatus for mode selection in a multi-mode mobile phone, wherein the multi-mode mobile phone can communicate with a plurality of communication systems, comprising: a selector, wherein the selector selects the phone number from a phone book; a predetermined communication system determination device is provided for determining whether a predetermined communication system information is set to the phone number or not; and a predetermined communication system dialing device is provided for selecting the predetermined communication system to dial the phone number based on the predetermined communication system information when the predetermined communication system information is set to the phone number.

In accordance with the foregoing embodiments of the present invention, the user can set the phone number for the predetermined communication system information. Then, the phone number is dialed by a communication system selected according to the predetermined communication system information. Thus, the user is able to dial quickly without a complicated operation.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a flow chart that illustrates a method for selecting a communication system according to one preferred embodiment of this present invention.

FIG. 2 is a block diagram that illustrates the function of the apparatus for selecting a communication system according to another preferred embodiment of this present invention.

FIG. 3 is a block diagram of the selector in FIG. 2.

### DESCRIPTION OF THE PREFERRED EMBODIMENTS

The making and using of the present preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

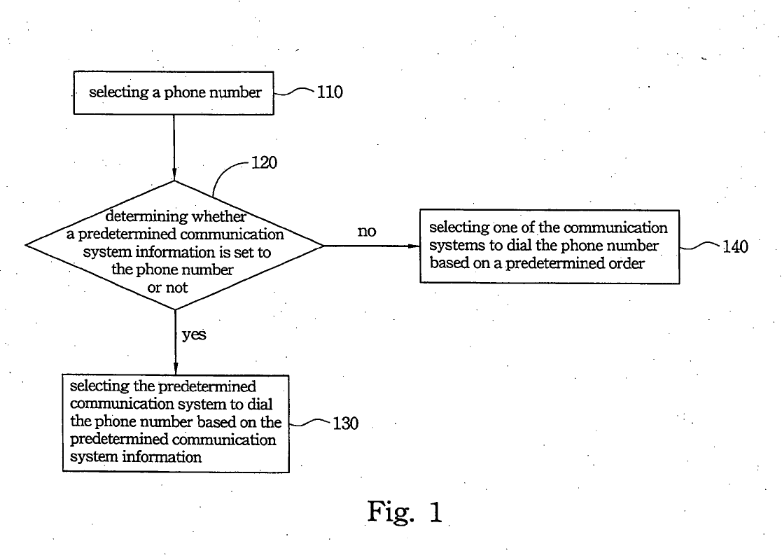

FIG. 1 is a flow chart that illustrates a method for selecting a communication system according to one preferred embodiment of this invention. With reference now to FIG. 1, shows a method for mode selection in a multi-mode mobile phone includes the following steps: Firstly, a phone number is selected from a phone book of the multi-mode mobile phone (step 110). Then, whether the phone number is set to correspond to a predetermined communication system information is determined (step 120). The phone number is dialed by a communication system selected according to the predetermined communication system information when the phone number is set to the predetermined communication system information (step 130).

In an embodiment to provide a method for mode selection, the user can set the phone number for the predetermined communication system information. Then, the phone number is dialed by a communication system selected according to the predetermined communication system information. Thus, the user may be able to dial quickly without complicated operation.

In one of the preferred embodiment, when the predetermined communication system information is not set to the phone number, then the phone number is dialed by a communication system selected according to the preferential communication system information (step 140). For example, a multi-mode mobile phone includes Global System of Mobile communication (GSM) and Personal Handyphone System (PHS). For example, when the user sets the PHS to take precedence over the GSM. In step 140, dialing the phone number by PHS is selected.

Moreover, another embodiment to provide a method for mode selection by hand-operation includes the following steps: Firstly, whether the multi-mode mobile phone is set on a hand-operation selection mode is determined. The phone number is dialed by one of a plurality of the communication systems selected by hand-operation when the multi-mode mobile phone is in the hand-operation selection mode. For example, as mentioned above, the hand-operation selection mode may be determined before step 120. Alternatively, the hand-operation selection mode may be able to determine after step 120. It will be readily understood by those skilled in the art that methods may be varied while remaining within the scope of the present invention.

For example, the phone number is dialed by one of a plurality of the communication systems selected by hand-operation when the communication system that is designated in step 130 has no signal. In one embodiment of the present invention, the multi-mode mobile phone can not automatically select another communication system when the communication system that is designated in step 130 has no signal. Thus the user may manually select one of the communication systems.

In another embodiment of the present invention, when the communication system that is designated in step 130 has no signal, the communication system can automatically select the communication system with reception signal to dial the phone number.

Moreover, the above-mentioned step 110 may includes the following steps: Firstly, a phone number of a contact person is selected from a phone book of the multi-mode mobile phone. The contact person may have a plurality of phone numbers, and these phone numbers may not belong to the same provider of the communication system. Therefore, the user may set the phone numbers of the contact person respectively to the predetermined communication system information. Of course, it is convenient for the user; the phone numbers of the contact person can be in the predetermined communication system information jointly. It will be readily understood by those skilled in the art that methods may be varied while remaining within the scope of the present invention.

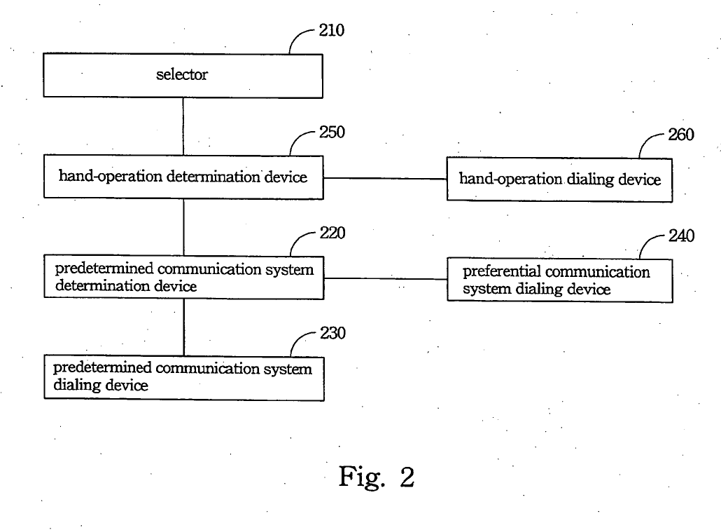

FIG. 2 is a block diagram that illustrates the function of the apparatus for selecting a communication system according to another preferred embodiment of this invention. FIG. 2 illustrates an apparatus for a mode selection in a multi-mode mobile phone. This apparatus includes a selector 210, wherein the selector 210 selects a phone number from the phone book of the multi-mode mobile phone; a predetermined communication system determination device 220 and a predetermined communication system dialing device 230. The predetermined communication system determination device 220 is for determining whether the phone number is in the predetermined communication system information or not. The predetermined communication system dialing device 230 is provided for selecting the predetermined communication system to dial the phone number based on the predetermined communication system information when the predetermined communication system information is set to the phone number.

In an embodiment to provide an apparatus for mode selection, the user can set the phone number in the predetermined communication system information. Then, the user dials the phone number based on the predetermined communication system information. Thus, the user may be able to dial quickly without complicated operations.

In an embodiment, an apparatus for mode selection includes the preferential communication system dialing device 240. Preferably, the preferential communication system dialing device 240 is provided for selecting one of the communication systems to dial the phone number based on a predetermined order when the predetermined communication system information is not set to the phone number. For example, a multi-mode mobile phone includes Global System of Mobile communication (GSM) and Personal Handyphone System (PHS). The user sets the PHS to take precedence over the GSM. The phone number is dialed by the PHS selected according to the preferential communication system dialing device 240.

In an embodiment, an apparatus for mode selection includes: a hand-operation determination device 250 and a hand-operation dialing device 260. The user may be able to select a communication system by hand-operation, wherein the hand-operation determination device 250 for judging whether the multi-mode mobile phone is in a hand-operation selection mode or not. A hand-operation dialing device is provided for selecting one of the communication systems to dial the phone number by the hand-operation selection mode when the multi-mode mobile phone is in a hand-operation selection mode. The above-mentioned hand-operation determination device 250 may be able to determine before the predetermined communication system determination device 220 determines. Alternatively, the hand-operation determination device 250 may be able to determine after the predetermined communication system determination device 220 determines. It will be readily understood by those skilled in the art that methods may be varied while remaining within the scope of the present invention.

For example, a hand-operation determination device 250 is provided for determining whether the multi-mode mobile phone is in a hand-operation selection mode or not when the predetermined communication system fails. The hand-operation dialing device 260 is provided for selecting one of the communication systems to dial the phone number by the hand-operation selection mode when the multi-mode mobile phone is in a hand-operation selection mode. In one embodiment, the multi-mode mobile phone cannot automatically select another communication system when the predetermined communication system dialing device 230 designates the communication system has no signal. Thus the user may select one of a plurality of communication systems by hand-operation.

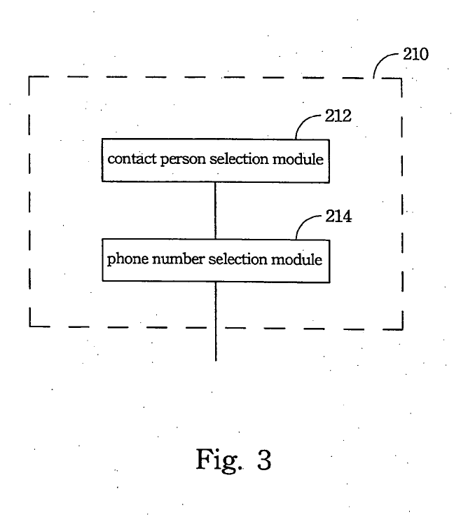

FIG. 3 is a block diagram according to the selector 210 in FIG. 2. This selector 210 includes a contact person selection module 212, wherein the contact person selection module selects a contact person from the phone book of the multi-mode mobile phone; and a phone number selection module 214, wherein the phone number selection module selects the phone number from the contact person. The contact person may have a plurality of phone numbers, thus these phone numbers may not belong to the same provider of communication system. Therefore, the user sets the phone numbers of the signal contact person respectively to the predetermined communication system information. Of course, it is convenient to the user that the phone numbers of the contact person can be in the predetermined communication system information jointly. It will be readily understood by those skilled in the art that methods may be varied while remaining within the scope of the present invention.

Therefore, the selector 210, the contact person selection module 212, the phone number selection module 214, the predetermined communication system determination device 220, the predetermined communication system dialing device 230, the preferential communication system dialing device 240, the hand-operation determination device 250, the hand-operation dialing device 260, and the embodiments thereof may use software or a circuit. It will be readily understood by those skilled in the art that methods may be varied while remaining within the scope of the present invention.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for mode selection in a multi-mode mobile phone, wherein the multi-mode mobile phone can communicate with a plurality of communication systems, comprising:
selecting a phone number from a phone book of the multi-mode mobile phone;
determining whether a predetermined communication system information is set to the phone number or not; and
selecting the predetermined communication system to dial the phone number based on the predetermined communication system information when the predetermined communication system information is set to the phone number.

2. The method of claim 1, further comprising:
selecting one of the communication systems to dial the phone number based on a predetermined order when the predetermined communication system information is not set to the phone number.

3. The method of claim 1, further comprising:
determining whether the multi-mode mobile phone is in a hand-operation selection mode or not; and
selecting one of the communication systems to dial the phone number by the hand-operation selection mode when the multi-mode mobile phone is in a hand-operation selection mode.

4. The method of claim 1, further comprising:
selecting one of the communication systems to dial the phone number manually when the predetermined communication system fails.

5. The method of claim 1, further comprising:
selecting one of the communication systems with reception signal to dial the phone number automatically when the predetermined communication system fails.

6. The method of claim 1, wherein the step of selecting a phone number further comprising:
selecting a contact person from a phone book in the multi-mode mobile phone; and
selecting the phone number from the contact person.

7. An apparatus for mode selection in a multi-mode mobile phone, wherein the multi-mode mobile phone can communicate with a plurality of communication systems, comprising:
a selector, is capable of selecting a phone number;
a predetermined communication system determination device, is capable of determining whether a predetermined communication system information is set to the phone number or not; and
a predetermined communication system dialing device, is capable of selecting the predetermined communication system to dial the phone number based on the predetermined communication system information when the predetermined communication system information is set to the phone number.

8. The apparatus of claim 7, further comprising:
a preferential communication system dialing device, is capable of selecting one of the communication systems to dial the phone number based on a predetermined order when the predetermined communication system information is not set to the phone number.

9. The apparatus of claim 7, further comprising:
a hand-operation determination device, is capable of determining whether the multi-mode mobile phone is in a hand-operation selection mode or not; and
a hand-operation dialing device, is capable of selecting one of the communication systems to dial the phone number by the hand-operation selection mode when the multi-mode mobile phone is in a hand-operation selection mode.

10. The apparatus of claim 7, further comprising:
a hand-operation determination device, is capable of determining whether the multi-mode mobile phone is in a hand-operation selection mode or not when the predetermined communication system fails; and
a hand-operation dialing device, is capable of selecting one of the communication systems to dial the phone number by the hand-operation selection mode when the multi-mode mobile phone is in a hand-operation selection mode.

11. The apparatus of claim 7, further comprising:
a contact person selection module, is capable of selecting a contact person from a phone book of the multi-mode mobile phone; and
a phone number selection module, is capable of selecting the phone number from the contact person.
